(19) United States
(12) Patent Application Publication
(10) Pub. No.: US 2025/0165127 A1
(43) Pub. Date: May 22, 2025

(54) INFORMATION INTERACTION

(71) Applicant: Beijing Zitiao Network Technology Co., Ltd., Beijing (CN)

(72) Inventors: Xiang Jiang, Beijing (CN); Runqiong Wang, Beijing (CN)

(21) Appl. No.: 18/950,599

(22) Filed: Nov. 18, 2024

(30) Foreign Application Priority Data
Nov. 20, 2023 (CN) 202311549974.0

(51) Int. Cl. G06F 3/0484; G06F 9/445

(52) U.S. Cl. CPC G06F 3/0484; G06F 9/44526

(57) ABSTRACT

According to embodiments of the disclosure, a method, apparatus, device and storage medium for information interaction are provided. In the method for information interaction, in an interaction window between a user and a digital assistant, in response to a first scenario of a set of scenarios being selected for an interaction between the user and the digital assistant, at least one first operation control associated with the first scenario is provided in the interaction window. At least one scenario of the set of scenarios is configured to perform a task related to the corresponding scenario, and the at least one first operation control is respectively configured to trigger a corresponding operation for the interaction.

### CROSS-REFERENCE

The present application claims priority to Chinese Patent Application No. 202311549974.0, filed on Nov. 20, 2023, and entitled “METHOD, APPARATUS, DEVICE AND STORAGE MEDIUM FOR INFORMATION INTERACTION”, the entirety of which is incorporated herein by reference.

### FIELD

Example embodiments of the present disclosure generally relate to the field of computers, and in particular, to information interaction.

### BACKGROUND

With the rapid development of Internet technologies, the Internet has become an important platform for people to obtain content and share content, and users can access the Internet through terminal devices to enjoy various Internet services. The terminal devices present the corresponding content through user interfaces of applications, implement interaction with the users and provide service to the users. Therefore, an interactive interface of a colorful application is an important means of improving user experience. With the development of information technologies, various terminal devices may provide various services to people in terms of work and life. For example, an application providing a service may be deployed in a terminal device. The terminal device or application may provide a digital assistant function to the user to assist the user in using the terminal device or application. How to improve the flexibility of interaction between a user and a digital assistant is a technical problem to be explored currently.

### SUMMARY

In a first aspect of the present disclosure, a method for information interaction is provided. The method includes, in an interaction window between a user and a digital assistant, in response to a first scenario of a set of scenarios being selected for an interaction between the user and the digital assistant, providing at least one first operation control associated with the first scenario in the interaction window. At least one scenario of the set of scenarios is configured to perform a task related to the corresponding scenario, and the at least one first operation control is respectively configured to trigger a corresponding operation for the interaction.

In a second aspect of the present disclosure, an apparatus for information interaction is provided. The apparatus includes: a control presenting module configured to, in an interaction window between a user and a digital assistant, in response to a first scenario of a set of scenarios being selected for an interaction between the user and the digital assistant, providing at least one first operation control associated with the first scenario in the interaction window. At least one scenario of the set of scenarios is configured to perform a task related to the corresponding scenario, and the at least one first operation control is respectively configured to trigger a corresponding operation for the interaction.

In a third aspect of the present disclosure, an electronic device is provided. The device includes: at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer readable storage medium is provided. The computer readable storage medium stores a computer program, and the computer program is executable by the processor to implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the disclosure can be implemented;

FIG. 2 illustrates a schematic diagram of an example client interface of an interaction window according to some embodiments of the present disclosure;

FIG. 3 illustrates a schematic diagram of an example interface for scenario selection according to some embodiments of the present disclosure;

FIG. 4A illustrates a schematic diagram of an example client interface of an interaction window in an example scenario according to some embodiments of the present disclosure;

FIG. 4B illustrates a schematic diagram of an example interface for file selection according to some embodiments of the present disclosure;

FIG. 4C illustrates a schematic diagram of an example client interface of an interaction window in an example scenario according to some embodiments of the present disclosure;

FIG. 5A illustrates a schematic diagram of an example client interface of an interaction window in an example scenario according to some embodiments of the present disclosure;

FIG. 5B illustrates a schematic diagram of an example interface for image selection according to some embodiments of the present disclosure;

FIG. 5C illustrates a schematic diagram of an example client interface of an interaction window in an example scenario according to some embodiments of the present disclosure;

FIGS. 6A and 6B illustrate schematic diagrams of an example client interface of an interaction window in an example scenario according to some embodiments of the present disclosure;

FIGS. 7A and 7B illustrate schematic diagrams of an example client interface of an interaction window in an example scenario according to some embodiments of the present disclosure;

FIG. 8A illustrates a schematic diagram of an example client interface of an interaction window in an example scenario according to some embodiments of the present disclosure;

FIG. 8B illustrates a schematic diagram of an example interface for presenting a shortcut instruction list according to some embodiments of the present disclosure;

FIG. 8C illustrates a schematic diagram of an example client interface of an interaction window in an example scenario according to some embodiments of the present disclosure;

FIG. 9 illustrates a flowchart of a process for information interaction according to some embodiments of the present disclosure;

FIG. 10 illustrates a block diagram of an apparatus for information interaction according to some embodiments of the present disclosure; and

FIG. 11 illustrates a block diagram of an electronic device in which one or more embodiments of the present disclosure may be implemented.

### DETAILED DESCRIPTION

The embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performing one step does not imply that this step is performed immediately after “A” but may include one or more intermediate steps.

It may be understood that the data involved in the technical solution (including but not limited to the data itself, the obtaining, using, storing or deleting of the data) should follow the requirements of the corresponding laws and regulations and related rules.

It can be understood that before using the technical solutions disclosed in the embodiments of the present disclosure, related users should be informed of the types, use ranges, usage scenes, and the like of the information related to the present disclosure in an appropriate manner according to relevant laws and regulations, and the authorization of the related users may be obtained, wherein the related users may include any type of rights body, such as individuals, businesses, and groups.

For example, in response to receiving an active request from a user, prompt information is sent to the related user to explicitly prompt the related user that the requested operations to be performed would require acquisition and use of information of the related user, such that the related user can autonomously select whether to provide information to software or hardware such as an electronic device, an application, a server, or a storage medium that performs the operations of the technical solution of the present disclosure, according to the prompt information.

As an optional but non-limiting implementation, in response to receiving an active request from a related user, a manner of sending prompt information to the related user may be, for example, a pop-up window, and the pop-up window may present the prompt information in a text manner. In addition, the pop-up window may further carry a selection control for the user to select “agree” or “disagree” to provide information to the electronic device.

It can be understood that the foregoing process of notifying and acquiring user authorization is merely illustrative and does not constitute a limitation on the implementations of the present disclosure, and other manners that meet related laws and regulations may also be applied to the implementations of the present disclosure.

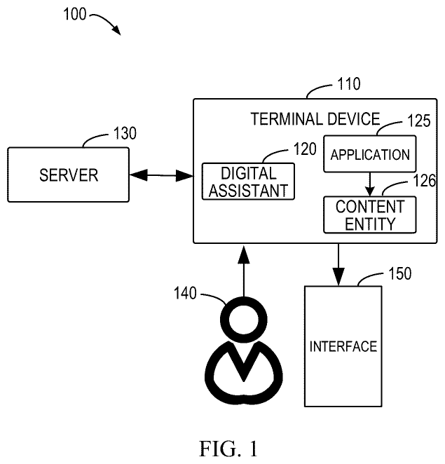

FIG. 1 illustrates a schematic diagram of an example environment 100 in which embodiments of the present disclosure can be implemented. In this example environment 100, a digital assistant 120 and an application 125 are installed in the terminal device 110. A user 140 may interact with the digital assistant 120 and the application 125 via the terminal device 110 and/or an attachment device of the terminal device 110.

In some embodiments, the digital assistant 120 and the application 125 may be downloaded, installed on the terminal device 110. In some embodiments, the digital assistant 120 and the application 125 may also be accessed in other manners, for example, accessed through a web page. In the environment 100 of FIG. 1, in response to the application 125 being launched, the terminal device 110 may present an interface 150 of the digital assistant 120 and the application 125.

The application 125 includes, but are not limited to, one or more of: chat applications (also referred to as instant messaging applications), document applications, audio and video conference applications, mail applications, task applications, calendar applications, objectives and key results (OKR) applications, and so forth. Although a single application is shown in FIG. 1, in practice, a plurality of applications may be installed on the terminal device 110. In some embodiments, the application 125 may include a multifunction collaboration platform, such as an office collaboration platform (also referred to as an office suite), which can provide integration of multiple types of applications or components, so that people can conveniently conduct activities such as office work and communication. In a multifunctional collaboration platform, people can start different applications or components according to the needs to complete corresponding information processing, sharing, communication and the like.

The application 125 may provide a content entity 126. The content entity 126 may be a content instance created by the user 140 or other users on the application 125. For example, depending on the type of the application 125, the content entity 126 may be a document (e.g., a word document, a pdf document, a presentation, a table document, etc.), a mail, a message (e.g., a conversation message on an instant messaging application), a calendar, a schedule, a task, an audio, a video, an image, or the like.

In some embodiments, the digital assistant 120 may be provided by a separate application or integrated into certain application 120 capable of providing the content entity. The application of the client interface for providing the digital assistant may correspond to a single functional application or a multifunction collaboration platform, such as an office suite or other collaboration platform capable of integrating a plurality of components. In some embodiments, the digital assistant 120 supports the use of plug-ins. Each plug-in may provide one or more functions of the application. Such plug-ins include, but are not limited to, one or more of: a search plug-in, a contact plug-in, a message plug-in, a document plug-in, a table plug-in, a mail plug-in, a calendar plug-in, a schedule plug-in, a task plug-in, and the like.

The digital assistant 120 is a user intelligent assistant and has an intelligent dialogue and information processing capability. In an embodiment of the present disclosure, the digital assistant 120 is configured to interact with the user 140 to assist the user 140 in using the terminal device or the application. An interaction window with the digital assistant 120 may be presented in the client interface. In the interaction window, the user 140 may interact with the digital assistant 120 by inputting natural language to indicate the digital assistant to assist in completing various tasks, including the operations of the content entity 126.

In some embodiments, the digital assistant 120 may be included as a contact of the user 140 in a contact list of the current user 140 in the office suite, or in the feed of the chat component. In some embodiments, the user 140 has a corresponding relation with the digital assistant 120. For example, the first digital assistant corresponds to the first user, the second digital assistant corresponds to the second user, and so on. In some embodiments, the first digital assistant may uniquely correspond to the first user, the second digital assistant may uniquely correspond to the second user, and so on. That is, the first digital assistant of the first user may be specific or dedicated to the first user. For example, in a process in which the first digital assistant provides assistance or service to the first user, the first digital assistant may utilize its historical interaction information with the first user, data authorized by the first user that can be accessed by the first digital assistant, current interaction context of the first digital assistant and the first user, and the like. If the first user is an individual or a person, the first digital assistant may be considered a personal digital assistant. It may be understood that, in the disclosed embodiment, the first digital assistant accesses the data granted rights based on the authorization of the first user. It should be understood that the “uniquely correspond” or the like in the present disclosure is not intended to limit that the first digital assistant will be updated accordingly based on the interaction process between the first user and the first digital assistant. Of course, the digital assistant 120 is not necessarily specific to the current user 140, but may be a universal digital assistant, depending on the needs of the actual application.

In some embodiments, a plurality of interaction modes between the user 140 and the digital assistant 120 may be provided and be flexibly switched between the plurality of interaction modes. If a certain interaction mode is triggered, a corresponding interaction area is presented to facilitate interaction between the user 140 and the digital assistant 120. The interaction manners between the user 140 and the digital assistant 120 in different interaction modes are different, which can flexibly be adapted to interaction requirements in different application scenes.

In some embodiments, the information handling service specific to the user 140 can be provided based on historical interaction information between the user 140 and the digital assistant 120 and/or a data range specific to the user 140. In some embodiments, the historical interaction information that the user 140 interacts with the digital assistant 120 in the plurality of interaction modes respectively may be stored in association with the user 140. As such, in one of the plurality of interaction modes (any or a designated interaction mode), the digital assistant 120 may provide services to the user 140 based on the historical interaction information stored in association with the user 140.

The digital assistant 120 may be called or activated in an appropriate manner (e.g., via a shortcut, a button, or a voice) to present an interaction window with the user 140. By selecting the digital assistant 120, an interaction window with the digital assistant 120 may be opened. The interaction window may include an interface element for information interaction, such as an input box, a message list, a message bubble, and the like. In some other embodiments, the digital assistant 120 may be invoked through an entry control or a menu provided in the page, or may be invoked by inputting a predetermined instruction.

In some embodiments, the interaction window between the digital assistant 120 and the user 140 may include a session window, such as a session window in an instant messaging application or an instant messaging module of the target application. In some embodiments, the interaction window between the digital assistant 120 and the user 140 may include a floating window corresponding to the digital assistant.

In some embodiments, the digital assistant 120 may support an interaction mode of a session window, also referred to as a conversation mode. In this interaction mode, a session window between the user 140 and the digital assistant 120 is presented, and the user 140 interacts with the digital assistant 120 through the conversation message in the session window. In the conversation mode, the digital assistant 120 may perform a task according to the conversation message in the session window.

In some embodiments, the conversation mode between the user 140 and the digital assistant 120 may be called or activated in an appropriate manner (e.g., a shortcut, a button, or a voice) to present the session window. By selecting the digital assistant 120, a session window with the digital assistant 120 may be opened. The session window may include interface elements for information interaction, such as input boxes, message lists, message bubbles, and the like.

In some embodiments, the digital assistant 120 may support a floating window (or floating window) interaction mode, also referred to as a floating window mode. If the floating window mode is triggered, an operation panel (also referred to as a floating window) corresponding to the digital assistant 120 is presented, and the user 140 may issue an instruction to the digital assistant 120 based on the operation panel. In some embodiments, the operation panel may include at least one candidate shortcut instruction. Alternatively, or additionally, the operation panel may include an input control for receiving instructions. In the floating window mode, the digital assistant 120 may perform a task according to an instruction issued by the user 140 through the operation panel.

In some embodiments, the floating window mode between the user 140 and the digital assistant 120 may also be called or activated in an appropriate manner (for example, a shortcut key, a button, or a voice) to present a corresponding operation panel. In some embodiments, the activation of the digital assistant 120 may be supported in a particular application, such as in a document application, to provide a floating window mode of interaction. In some embodiments, to trigger the floating window mode to present the operation panel corresponding to the digital assistant 120, an entry control for the digital assistant 120 may be presented in the application interface. In response to detecting the trigger operation for the entry control, it may be determined that the floating window mode is triggered and the operation panel corresponding to the digital assistant 120 is presented in the target interface area.

In some embodiments described below, for ease of discussion, the interaction window between the user and the digital assistant being is a session window is mainly used as an example for description.

In some embodiments, the terminal device 110 communicates with the server 130 to enable provisioning of services to the digital assistant 120 and the application 125. The terminal device 110 may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices, or any combination thereof. In some embodiments, the terminal device 110 may further support any type of interface for a user (such as a “wearable” circuit, etc.). The server 130 may be various types of computing systems/servers that can provide computing capabilities, including, but not limited to, mainframes, edge computing nodes, computing devices in a cloud environment, and the like.

It should be understood that the structures and functions of the various elements in the environment 100 are described for exemplary purposes only and do not imply any limitation to the scope of the present disclosure.

As briefly mentioned above, a digital assistant may assist a user in using a terminal device or an application. Some applications can provide integrated functionality for different plug-ins. In addition to the free dialogue with the digital assistant, the user can make the digital assistant complete some more complex operations related to the business of the application by using different plug-ins through the natural language instruction, such as creating a document, inviting a schedule, creating a task, and the like. However, since most users cannot explore the use scenario of the digital assistant through interaction with the digital assistant, targeted guidance needs to be provided for the user. In addition, traditionally, users often need to input corresponding information to instruct the digital assistant to perform different tasks in different scenarios. If the operation is complex or the description of the operation is complex, the information that the user needs to input may also be correspondingly more. In addition, the instruction input by the user is not clear enough, resulting in the situation that the digital assistant cannot clarify the corresponding operation. This can affect the interaction efficiency of the user and the digital assistant and make the interaction function of the digital assistant not flexible enough.

According to some embodiments of the present disclosure, an improved solution for information interaction is presented. In the embodiments of the present disclosure, in an interaction window between a user and a digital assistant, in response to a first scenario of a set of scenarios being selected for an interaction between the user and the digital assistant, at least one first operation control associated with the first scenario is provided in the interaction window. At least one scenario of the set of scenarios is configured to perform a task related to the corresponding scenario, and the at least one first operation control is respectively configured to trigger a corresponding operation for the interaction.

In the general solution, users are usually only allowed to select plug-ins to communicate with digital assistants, but this requires the user to have a certain cognitive height, know what plug-ins should be selected in what task scenario, and need to manually select the plug-ins to be used. According to the embodiment of the present disclosure, by providing the scenario-based interaction, the threshold for the user to get started using the digital assistant is reduced, and the operation of the user is simplified. Further, in the embodiments of the present disclosure, in the interaction based on a specific scenario, an operation control associated with the specific scenario may further be presented. An operation corresponding to the operation control may be performed in response to receiving a trigger operation on the operation control. This helps to reduce the difficulty and complexity of interaction between the user and the digital assistant and improve the interaction efficiency.

Some example embodiments of the disclosure will be described in detail below with reference to examples of the accompanying drawings.

As described above, in an embodiment of the disclosure, the digital assistant is configured to interact with a user. An interactive window between the user and the digital assistant may be presented in a client interface. The interaction window between the user and the digital assistant may include a session window, and the interaction between the user and the digital assistant in the session window may be presented in the form of a conversation message. Alternatively, or additionally, the interaction window between the user and the digital assistant may further include other types of windows, such as a window of a floating window mode, where the user may trigger the digital assistant to perform corresponding operations by inputting an instruction, selecting a shortcut instruction, or the like. The digital assistant serves as an intelligent assistant and has an intelligent dialogue and information processing capability. In the interaction window, the user inputs an interaction message, and the digital assistant provides a reply message in response to the user input. A client interface for providing the digital assistant may correspond to a single functional application or a multifunction collaboration platform, such as an office suite or other collaboration platform capable of integrating a plurality of components.

In some embodiments, the terminal device 110 may present a session window between the user and a further user or a plurality of users. A session window of the user and the further user herein may be, for example, a single chat window between a user A and user B. A session window of the user and the plurality of users may be, for example, a group chat window of the user A and another group of users. A user may interact with at least one other user by sending and/or receiving messages in the session window. For example, the terminal device 110 may determine, in response to detecting a text input by the user in an input box, a message content to be sent by the user. For example, the terminal device 110 may further collect a user audio in response to detecting a trigger operation of the user on an audio space. The terminal device 110 may determine the audio or a text content corresponding to the audio as the message content to be sent by the user. It should be noted that operations performed by the terminal device 110 and operations performed by the terminal device 110 described subsequently may be specifically performed by a related application installed on the terminal device 110.

In a session window, a user may enter a message through an input box or by other appropriate means (e.g., voice), and the digital assistant may provide a reply message based on the input message and in conjunction with relevant knowledge. The messages in the session window are typically session messages. Such a session message may be considered part of a certain topic.

Herein, a “topic” corresponds to a particular context of an interaction. During the interaction process of each topic, interaction information of the user and the digital assistant may be considered as context information, to assist the digital assistant in determining a subsequent session message. In some embodiments, a topic is also sometimes referred to as or presented as a subject matter.

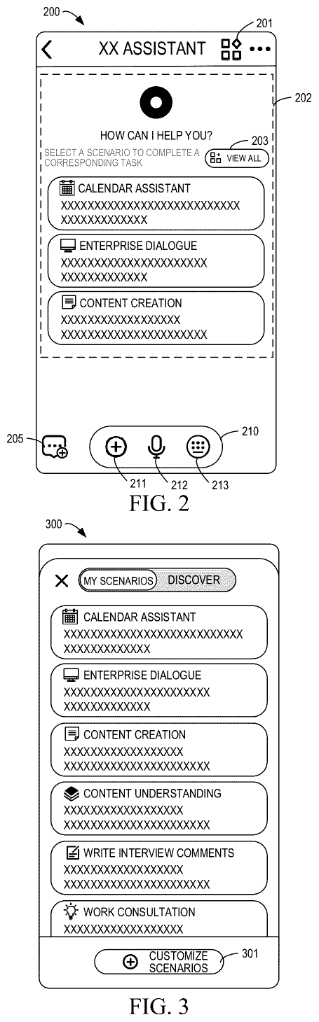

FIG. 2 illustrates a schematic diagram of an example client interface 200 of an interaction window according to some embodiments of the present disclosure. The client interfaces shown in FIG. 2 and subsequent other figures may all be implemented at the terminal device 110. Examples of FIG. 2 and subsequent other figures will be described below with reference to FIG. 1.

In a session window between a user and another at least one user, the terminal device 110 (for example, an instant messaging application installed on the terminal device 110, or a suite application integrated with an instant messaging application installed on the terminal device 110) may present, in response to detecting a predetermined input in an input box of the session window, a trigger control on the digital assistant (for example, a first digital assistant). In some embodiments, the starting entry of the instant messaging application and/or the feed of the instant messaging application may be presented in the interface 200 (not shown). In response to the user selecting any contact or any group from the feed of the instant messaging application, the terminal device 110 may present a corresponding session window in the interface 200. For example, in response to the user invoking the digital assistant through a predetermined operation (for example, selecting the digital assistant from a contact list), the terminal device 110 may present, in the interface 200, a session window (also referred to as a main session window) that the user interacts with the digital assistant (that is, the XX assistant in the figure).

In some embodiments, the terminal device 110 may present, in response to a new topic starting operation, a new topic guidance message in the session window in which the user interacts with the digital assistant. The new topic guidance message may include, for example, at least one scenario and/or at least one historical topic in the session between the user and the digital assistant. Regarding the new topic starting operation, in some embodiments, in response to the digital assistant being invoked, the terminal device 110 may default to receiving the new topic starting operation, start a new topic in the session window, and present the new topic guidance message in the session window. In some embodiments, if there is historical interaction information or a historical topic between the user and the digital assistant, in response to the digital assistant being invoked, the terminal device 110 may present the historical interaction information or the portion of the historical topic in the session window. Alternatively, or additionally, in some embodiments, in response to the digital assistant being invoked, the terminal device 110 may not present any message in the main session window as well.

In some embodiments, the session window may include an input box, and the terminal device 110 may, for example, receive the user input through the input box. The terminal device 110 may determine to receive a new topic starting operation in response to detecting that the user input is a user input indicating to open a new topic. In some embodiments, the session window may further include a control for starting a new topic. For example, the terminal device 110 may determine to receive a new topic starting operation, for example, in response to detecting a trigger operation on the control (for example, a click operation, a long-press operation, a double-click operation, or the like). Then, the terminal device 110 may start a new topic in the session window and present a new topic guidance message in the session window. As shown in FIG. 2, in some embodiments, in response to the digital assistant being invoked, the terminal device 110 may default to presenting a new topic guidance message 202 in the interface 200. In some embodiments, the interface 200 may further include a control 205 for starting a new topic. The terminal device 110 may present a new topic guidance message 202 in the interface 200 in response to detecting a trigger operation on the control 205. In some embodiments, the terminal device 110 may further present the new topic guidance message by presenting a message card.

The terminal device 110 may present at least one scenario (e.g., a scenario “calendar assistant”, scenario “enterprise dialog”, and scenario “content creation”) in the new topic guidance message 202. The scenario herein refers to a set of tasks of the same type, that is, one scenario corresponds to multiple tasks of the same type. One or more scenarios may be configured with corresponding configuration information to perform corresponding types of tasks, respectively. For ease of understanding, a scenario applied in the interaction between the user and digital assistant is briefly introduced first.

The configuration information of the scenario includes at least one of: scenario setting information or plug-in information. The scenario setting information is used to describe information related to the corresponding scenario. The scenario setting information of the scenario may affect the reply of the digital assistant to the user to a certain extent or be used to determine the reply of the digital assistant to the user. In some embodiments, the scenario setting information is used to construct a prompt input to provide to a model used in the corresponding scenario. The digital assistant's reply to the user is based on the output of the model. For example, the scenario setting information of the scenario may include a description of the corresponding type of task, a reply style of the digital assistant in the scenario, a definition of a workflow to be executed in the corresponding scenario, a definition of a reply format of the digital assistant in the corresponding scenario, and the like. In some embodiments, the digital assistant utilizes a model to understand the user input and provide the reply to the user based on the output of the model. The model used by the digital assistant may run locally on the terminal device 110 or on a remote server. By constructing a part of the prompt input of the model by using the scenario setting information, the model may be guided to complete the task to be implemented in the corresponding scenario. In some embodiments, the model may be a machine learning model, a deep learning model, a learning model, a neural network, or the like. In some embodiments, the model may be based on a language model (LM). The language model may have question-answering capability by learning from a large number of corpora. The model may further be based on other appropriate models.

The plug-in information indicates at least one plug-in for performing a task in the corresponding scenario. Through the plug-in information of the scenario, the plug-in to be used in the corresponding scenario may be configured. In some embodiments, in the corresponding scenario, the plug-in may further call the model to complete the corresponding task in the running of the plug-in. In some embodiments, a certain plug-in may further call an open interface provided by another application (for example, an application such as a document, a calendar, a conference, etc.) to complete a corresponding task, such as modifying a document, creating a schedule, summarizing a conference, and the like.

In some embodiments, the configuration information of the scenario may further include a scenario name, description information of the scenario, and the like. In some embodiments, the terminal device 110 may provide a message card to the user in the session window, and at least part of the set of scenarios may be presented in the message card. The terminal device 110 may present, in association with the scenario, the scenario name of the corresponding scenario and/or the description information of the scenario in the message card. The user may, for example, select, based on the scenario name and/or the description information of the scenario presented in the message card, the scenario that meets the requirements of the user himself.

In some embodiments, the configuration information of the scenario may further include, but is not limited to, a selected model (the model herein is called to determine a reply to the user in the corresponding scenario), scenario guidance information (the scenario guidance information is presented to the user after the corresponding scenario is selected), at least one recommended question for the digital assistant (the at least one recommended question is presented to the user for selection after the corresponding scenario is selected), any combination of the one or more foregoing items, or the like. The scenario guidance information may be, for example, description information of a task instance that may be performed in the scenario. In some embodiments, the configuration for the scenario setting information and the configuration information of the scenario may be completed in a natural language manner, such that the scenario creator may conveniently constrain the output of the model and configure diversified scenarios.

In some embodiments, the configuration information of the scenario may further indicate at least one operation control associated with the scenario. As will be described in detail below, the at least one operating control associated with the scenario may be presented to the user if the scenario is selected for interaction to facilitate the user's interaction with the digital assistant in the corresponding scenario. That is, in the scenario creation process, the at least one operation control associated with the scenario may be configured by the scenario creator. In some embodiments, the configuration for the scenario setting information and the configuration information of the scenario may be configured by the scenario creator in a natural language manner, for example. In this way, the creator of the scenario can conveniently constrain the output of the model and configure diversified scenarios.

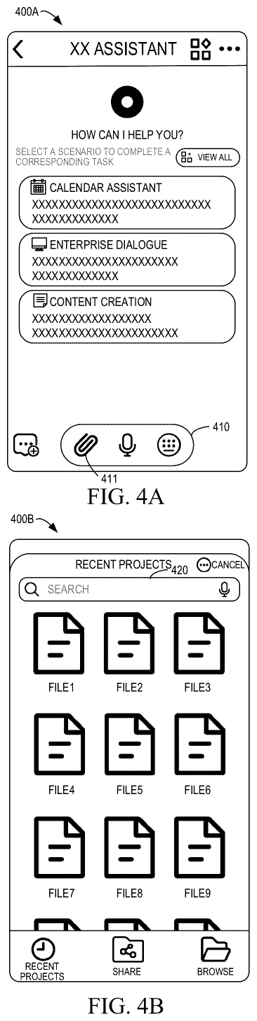

In some embodiments, for example, the terminal device 110 may further present a scenario viewing entry 201 in the interface 200 and/or present a scenario viewing entry 203 in the new topic guidance message 202. The terminal device 110 may present more scenarios in response to detecting a trigger operation on the scenario viewing entry 201 and/or the scenario viewing entry 203. For example, in order to ensure the simplicity of the main session window, if multiple scenarios are included, the terminal device 110 may only present a partial scenario in the new topic guidance message 202, and present more selectable scenarios in response to detecting a trigger operation on the scenario view entry 201 or the scenario view entry 203. For example, in response to detecting a trigger operation on the scenario view entry 201 or the scenario view entry 203, the terminal device 110 may present an interface 300 as shown in FIG. 3.

As shown in FIG. 3, a plurality of scenarios and a scenario creation entry 301 are presented in the interface 300. The user may create a scenario, for example, by triggering the scenario creation entry 301. The terminal device 110 may, for example, determine that a scenario creation operation is received in response to detecting a trigger operation on the scenario creation entry 301, and provide a page (sometimes also referred to as a “first page”) for creating a target scenario. The terminal device 110 may obtain target configuration information of the target scenario via the first page. The target configuration information may indicate at least one operation control associated with the target scenario. The terminal device 110 may further, in response to receiving a creation confirmation operation, create the target scenario based on the obtained target configuration information. As mentioned above, the configuration information of the target scenario includes one or more of: scenario setting information of the target scenario, plug-in information, an indication of the selected model, scenario guidance information, at least one recommended question for the digital assistant, and at least one operation control associated with the scenario. Therefore, the user may customize the target configuration information of the target scenario via the first page, so that the terminal device 110 creates the target scenario matching the user requirement based on the target configuration information input by the user. For example, the user may customize at least one target operation control associated with the target scenario via the first page. The terminal device 110 may determine at least one target operation control of the target scenario based on the user input.

In some embodiments, the terminal device 110 may further present at least one historical topic in the new topic guidance message 202. For example, the terminal device 110 may determine all historical topics in the session between the user and the digital assistant as at least one historical topic included in the new topic guidance message, that is, the terminal device 110 may present all historical topics in the new topic guidance message. In some embodiments, to ensure simplicity of the interface, at least one historical topic included in the new topic guidance message 202 may further include only the predetermined number of recent historical topics. This predetermined number may be predetermined, for example, by a user and/or associated background staff. For example, if the predetermined number is 3 and there are 5 historical topics, the terminal device 110 may determine, based on their respective update times, 3 recent historical topics closest to the current time. The terminal device 110 may determine the 3 recent historical topics as at least one historical topic included in the new topic guidance message 202. It may be understood that, if the number of historical topics is less than a predetermined number, the terminal device 110 may determine all historical topics as at least one historical topic included in the new topic guidance message 202.

The terminal device 110 may, for example, determine that the selection of the first scenario is received in response to receiving a selection operation on a certain scenario (for example, a first scenario) in the at least one scenario presented in the new topic guidance message 202. The terminal device 110 may further perform interaction between the user and the digital assistant in the new topic based on at least the configuration information of the first scenario. The terminal device 110 may further determine, in response to receiving a selection operation on a certain historical topic (for example, the first historical topic) in the at least one historical topic presented in the new topic guidance message 202, that the selection of the first historical topic is received. The terminal device 110 may further present a first topic area corresponding to the first topic. The first topic area includes a session message related to the first topic in the first session.

In some embodiments, the terminal device 110 may further present at least one operation control in the session window (for example, the session window in the interface 200). Each operation control may be triggered to perform operations associated with the interaction between the user and the digital assistant, such as operations corresponding to input at the time of interaction. It may be understood that the terminal device 110 may present the operation control at any position of the session window, and the present disclosure does not limit the specific presentation position/area of the operation control. In some embodiments, the interaction window includes one or more predetermined operation controls with no scenario being selected for the interaction between the user and the digital assistant. The predetermined operation control may be, for example, a predetermined operation control predetermined by a user or related staff (for example, a creator of the digital assistant and/or application). The predetermined operation control may further be an operation control determined by the terminal device 110 based on the historical interaction between the user and the digital assistant. The terminal device 110 may provide, in the session window, at least one first operation control associated with the first scenario in response to a first scenario of the set of scenarios being selected for interaction of the user with the digital assistant. The “first scenario” herein refers to any scenario selected for interaction within a set of scenarios. At least one scenario of the set of scenarios is configured to perform a task related to the corresponding scenario, and the at least one first operation control is configured to trigger a corresponding operation for interaction, respectively. It should be noted that the predetermined operation control and the operation control corresponding to the scenario herein include an operation control (for example, a system component) that can be provided by the terminal device 110, or a particular operation control that may be developed and/or customized by the user.

Regarding the specific manner of providing the at least one first operation control, in some embodiments, if the first scenario is selected for an interaction between the user and the digital assistant, the terminal device 110 may place the at least one first operation control in front of at least one predetermined operation control in the interaction window. Herein, the at least one predetermined operation control may be all predetermined operation controls of one or more predetermined operation controls included in the interaction window. For example, if the terminal device 110 presents 3 predetermined operation controls in the session window with no scenario being selected, and the configuration information of the first scenario indicates 2 first operation controls associated with the first scenario. If the first scenario is selected, the terminal device 110 may place the 2 first operation controls corresponding to the first scenario in front of 3 predetermined operation controls in the interaction window. That is, the terminal device 110 switches from presenting 3 predetermined operation controls to presenting 5 operation controls including the 2 first operation controls and 3 predetermined operation controls. Alternatively, or additionally, the at least one predetermined operation control herein may further be part of the predetermined operation control(s) of one or more predetermined operation controls included in the interaction window. For example, if the terminal device 110 presents 3 predetermined operation controls in the session window with no scenario being selected, and the configuration information of the first scenario indicates 2 first operation controls associated with the first scenario. If the first scenario is selected, the terminal device 110 may place the 2 first operation controls corresponding to the first scenario between the first predetermined operation control and the second predetermined operation control in the interaction window. In this case, the 2 first operation controls are placed before the 2 predetermined operation controls and after 1 predetermined operation control in the interaction window. Note that the specific numbers of operation controls listed here and below are all examples.

In some embodiments, if the sum of the number of the one or more predetermined operation controls and the number of the at least one first operation control is larger, the terminal device 110 may only present the top few operation controls in the sorting. For example, if the terminal device 110 presents 3 predetermined operation controls in the session window with no scenario being selected, the configuration information of the first scenario indicates 3 first operation controls associated with the first scenario, and the sum of the number of the one or more predetermined operation controls and the number of the at least one first operation control is 6. In order to ensure the simplicity of the session window, the terminal device 110 may only present the top 3 operation controls of the 6 operation controls in the sorting. The terminal device 110 may present, in response to detecting a sliding operation or any other appropriate operation, 3 other operation controls of the 6operation controls. In some embodiments, the terminal device 110 may determine the sorting of the at least one first operation control to preferentially present at least one first operation control.

In some embodiments, if the first scenario is selected for the interaction between the user and the digital assistant, the terminal device 110 may further replace at least one predetermined operation control of the one or more predetermined operation controls with the at least one first operation control. For example, if the terminal device 110 presents 3 predetermined operation controls in the session window with no scenario being selected, and the configuration information of the first scenario indicates 2 first operation controls associated with the first scenario. If the first scenario is selected, the terminal device 110 may replace 2 predetermined operation controls of the 3 predetermined operation controls with the 2 first operation controls corresponding to the first scenario. That is, the terminal device 110 switches from presenting 3 predetermined operation controls to presenting 2 first operation controls and 1 predetermined operation controls. In some embodiments, the terminal device 110 may further replace at least one of the one or more predetermined operation controls with only part of the at least one first operation control. For example, if the terminal device 110 presents 3 predetermined operation controls in the session window with no scenario being selected, and the configuration information of the first scenario indicates 2 first operation controls associated with the first scenario. If the first scenario is selected, the terminal device 110 may replace 1 predetermined operation control of the 3 predetermined operation controls with 1 first operation controls of the 2 first operation controls corresponding to the first scenario. That is, the terminal device 110 switches from presenting 3 predetermined operation controls to presenting 1 first operation controls and 2 predetermined operation controls.

In some embodiments, the terminal device 110 may present an operation bar (also referred to as a functional island, an island, an operation island, etc.) in the session window. The terminal device 110 may present, in the operation bar, at least one operation control usable for interaction by the user with the digital assistant. For ease of description, an example in which at least one operation control (for example, one or more predetermined operation controls, at least one first operation control associated with the first scenario, etc.) is presented in the operation bar is used as an example for description. If there is no scenario selected for the interaction between the user and the digital assistant, the terminal device 110 may present one or more predetermined operation controls (also sometimes referred to as default operation controls) in the operation bar. For example, as shown in FIG. 2, the interface 200 may be an interface with no scenario being selected for an interaction between the user and the digital assistant. The terminal device 110 may present an operation bar 210 in the interface 200 and present one or more predetermined operation controls (e.g., a predetermined operation control 211, a predetermined operation control 212, and a predetermined operation control 213) in the operation bar 210. For example, the terminal device 110 may obtain any appropriate type of data item (for example, may be a text, an image, a video, etc.) input by the user in response to detecting a trigger operation on the predetermined operation control 211. For example, the terminal device 110 may obtain a user audio in response to detecting a trigger operation on the predetermined operation control 212. The terminal device 110, for example, may present an input panel in response to detecting a trigger operation on the predetermined operation control 213, and obtain text information input by the user via the input panel.

In response to the first scenario being selected for the interaction between the user and the digital assistant, the terminal device 110 may present, in the operation bar, at least one first operation control associated with the first scenario. Because the size of the operation bar is limited, the terminal device 110 may replace at least one of the one or more predetermined operation controls in the operation bar with the at least one first operation control. In some embodiments, in order to ensure the convenience of the operation of the user in the scenario, the terminal device 110 may preferentially replace the previous at least one predetermined operation control in the operation bar with the operation control corresponding to the scenario. For example, if there is only 1 first operation control, the terminal device 110 may replace the first predetermined operation control in the operation bar with the first operation control.

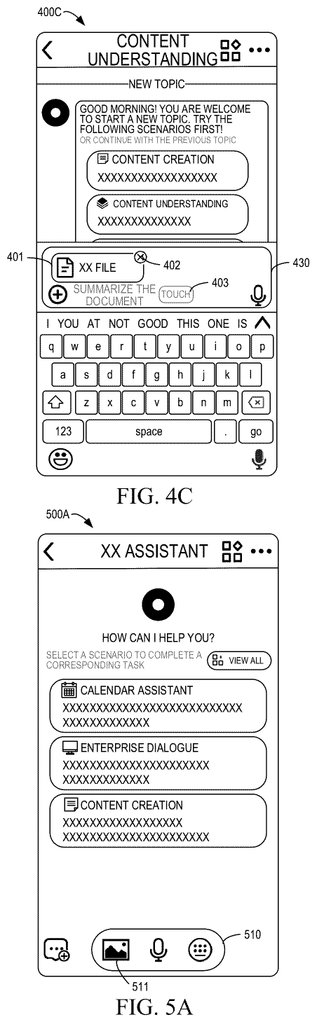

The terminal device 110 may further perform an operation corresponding to the first operation control in response to a trigger operation on the first operation control of the at least one first operation control in the interaction window (for example, in the operation bar of the interaction window). Below, in conjunction with FIGS. 4A-8C, specific examples are described in which the terminal device 110 using one or more operation controls associated with the selected scenario to replace one or more predetermined operation controls in the operation bar and subsequent interactions in the case that some example scenarios are selected. The description of these examples is merely intended to facilitate understanding of example embodiments of the present disclosure, and these specific scenarios and given specific operation controls are all examples.

In some embodiments, the at least one first operation control associated with the first scenario may include an input control for a respective type of information input. Taking the first scenario selected as a scenario “content understanding” as an example, the terminal device 110 may determine, based on the configuration information of the scenario “content understanding”, that the scenario “content understanding” is only associated with 1 operation control. The operation control may be, for example, an input control for receiving information of a file type. For ease of description, the following describes an example in which the selected scenario is only associated with 1 operation control as an example. The terminal device 110 may switch from presenting the interface 200 shown in FIG. 2 to presenting an interface 400A shown in FIG. 4A. An operation bar 410 in the interface 400A may correspond to the operation bar 210 in the interface 200. The operation bar 410 is presented with an operation control 411 corresponding to the scenario “content understanding” and 2 predetermined operation controls. The operation control 411 may be, for example, an input control for receiving information of a file type (also referred to as a file for short). The terminal device 110 may present an interface 400B shown in FIG. 4B in response to receiving a trigger operation on the operation control 411.

At least one file may be presented in the interface 400B. The terminal device 110 may further present more files in response to detecting a sliding operation (e.g., an upward sliding operation, a downward sliding operation, etc.) in the interface 400B. In some embodiments, the terminal device 110 may further present a search entry 420 in the interface 400B. The terminal device 110 queries a file matching a user input in response to receiving the user input through the search entry 420 and presents the queried file in the interface 400B. In some embodiments, if a file matching the user input is not found, the terminal device 110 may further present, in the interface 400B, prompt information for prompting that no file is found.

The terminal device 110 may, for example, determine that a user input including the at least one file is received in response to detecting a selection operation on at least one file in the interface 400B. The terminal device 110 may switch back to the session window presenting the interaction between the user and the digital assistant. For example, the terminal device 110 may present an interface 400C as shown in FIG. 4C. As shown in FIG. 4C, the terminal device 110 may present an input panel in the interface 400C. The input panel includes an input box 430. The terminal device 110 may present the received at least one file (that is, at least one file selected by the user in the interface 400B) in the input box 430. The terminal device 110 may further present, in association with the at least one file, a cancel control (for example, the relation between a file and cancel control is a one-to-one correspondence). For example, if the terminal device 110 only receives a file 401, the terminal device 110 may present, in association with the file 401, a cancel control 402. The terminal device 110 may delete the file 401 in the input box 430, that is, delete the received file 401, in response to receiving a selection operation on the cancel control 402. The terminal device 110 may receive a user input via the input box 430. If the received file is presented in the input box 430, the terminal device 110 may receive, via the input box 430, an instruction input by the user indicating an operation for the file. The terminal device 110 may further present, for example, a recommendation instruction for the received file in the input box 430. The recommendation instruction may be predetermined by the user and/or related staff or may be determined by the terminal device 110. The terminal device 110 may present a control 403 in the input box 430. The terminal device 110 may perform an operation on the received file based on the recommendation instruction in the input box 430 in response to detecting a trigger operation on the control 403. For example, the terminal device 110 may present the recommendation instruction “summarize the document” in the input box 430. The terminal device 110 may perform an operation on the file 401 based on the recommended instruction “summarize the document” in response to detecting a trigger operation on the control 403.

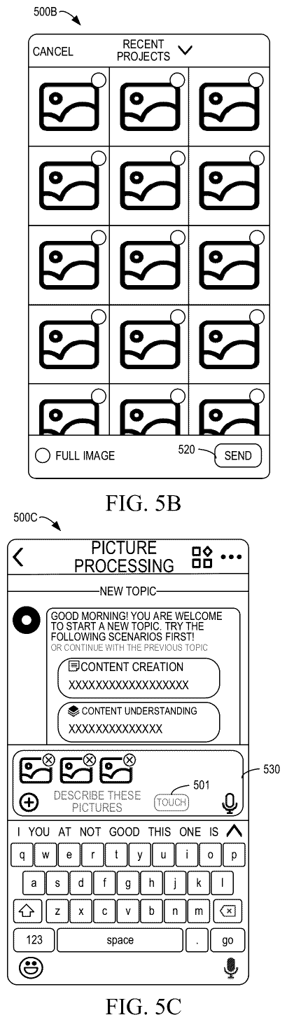

Taking the first scenario selected as a scenario “picture processing” as an example, the terminal device 110 may determine, based on the configuration information of the scenario “picture processing”, that the scenario “picture processing” is only associated with 1 operation control. The operation control may be, for example, an input control for receiving information of a file type as well. The terminal device 110 may switch from presenting the interface 200 shown in FIG. 2 to presenting an interface 500A shown in FIG. 5A. An operation bar 510 in the interface 500A may correspond to the operation bar 210 in the interface 200. The operation bar 510 is presented with an operation control 511 corresponding to the scenario “picture processing” and 2 predetermined operation controls. The operation control 511 may be, for example, an input control for receiving information of an image type (also referred to as an image for short). The terminal device 110 may present the interface 500B shown in FIG. 5B in response to receiving a trigger operation on the operation control 511.

At least one image may be presented in the interface 500B. The terminal device 110 may further present more images in response to detecting a sliding operation in the interface 500B. The terminal device 110 may, for example, in response to detecting a selection operation on at least one image in the interface 500B, determine that a user input including the at least one image is received. In order to prevent a situation that the user accidentally touches, in some embodiments, the terminal device 110 may further present an operation control 520 in the interface 500B. After receiving the selection operation on the at least one image, the terminal device 110 determines that the user input including the at least one image is received only if the trigger operation on the operation control 520 is received.

The terminal device 110 may switch back to the session window presenting the interaction between the user and the digital assistant. For example, the terminal device 110 may present an interface 500C as shown in FIG. 5C. As shown in FIG. 5C, the terminal device 110 may present an input panel in the interface 500C. The input panel includes an input box 530. The terminal device 110 may present the received at least one image (that is, at least one image selected by the user in the interface 500B) in the input box 530. The terminal device 110 may further present, in association with the at least one image, a cancel control (for example, the relation between an image and cancel control is a one-to-one correspondence). The terminal device 110 may delete a corresponding image in the input box 530 in response to receiving a selection operation on the cancel control. The terminal device 110 may receive a user input via the input box 530. If the received image is presented in the input box 530, the terminal device 110 may receive, via the input box 530, an instruction input by the user indicating an operation for the image. For example, the terminal device 110 may further present a recommendation instruction for the received image in the input box 530. Similarly, the recommendation instruction may be predetermined by the user and/or related staff or may be determined by the terminal device 110. The terminal device 110 may present a control 501 in the input box 530. The terminal device 110 may perform an operation on the received image based on the recommendation instruction in the input box 530 in response to detecting a trigger operation on the control 501. For example, the terminal device 110 may present a recommendation instruction “describe these pictures” in the input box 530. The terminal device 110 may perform, in response to detecting a trigger operation on the control 501, the operation for the received image based on the recommendation instruction “describe these pictures”.

In some embodiments, the at least one first operation control associated with the first scenario may further include a shortcut instruction control for triggering a shortcut instruction to interact with the digital assistant in the first scenario. The shortcut instruction herein may be predetermined by the user and/or related staff or may be determined by the terminal device 110.

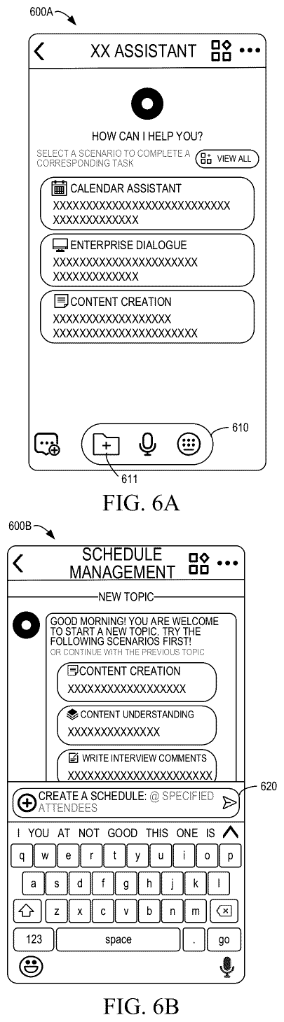

Taking the first scenario selected as a scenario “schedule management” as an example, the terminal device 110 may determine that the scenario “schedule management” is only associated with 1 operation control based on the configuration information of the scenario “schedule management”. The operation control may be, for example, a shortcut instruction control for triggering a shortcut instruction that interacts with the digital assistant under the scenario “schedule management”. The terminal device 110 may switch from presenting the interface 200 shown in FIG. 2 to presenting an interface 600A shown in FIG. 6A. An operation bar 610 in the interface 600A may correspond to the operation bar 210 in the interface 200. The operation bar 610 presents an operation control 611 corresponding to the scenario “schedule management” and 2 predetermined operation controls. The operation control 611 may be, for example, a shortcut instruction control for triggering a shortcut instruction that interacts with the digital assistant under the scenario “schedule management”. The terminal device 110 may determine, in response to receiving a trigger operation on the operation control 611, that a shortcut instruction for interacting with the digital assistant under the scenario “schedule management” is received.

The terminal device 110 may switch back to the session window presenting the interaction between the user and the digital assistant. For example, the terminal device 110 may present an interface 600B as shown in FIG. 6B. As shown in FIG. 6B, the terminal device 110 may present an input panel in the interface 600B. The input panel includes an input box 620. The terminal device 110 may present the received shortcut instruction (that is, an instruction “create a schedule”) in the input box 620. The terminal device 110 may further present, in the input box 620, prompt information related to the shortcut instruction. For example, the terminal device 110 may present the prompt information “@ specified attendees” in the input box 620. The terminal device 110 may perform a corresponding operation based on the received shortcut instruction and a text input by the user based on the prompt information.

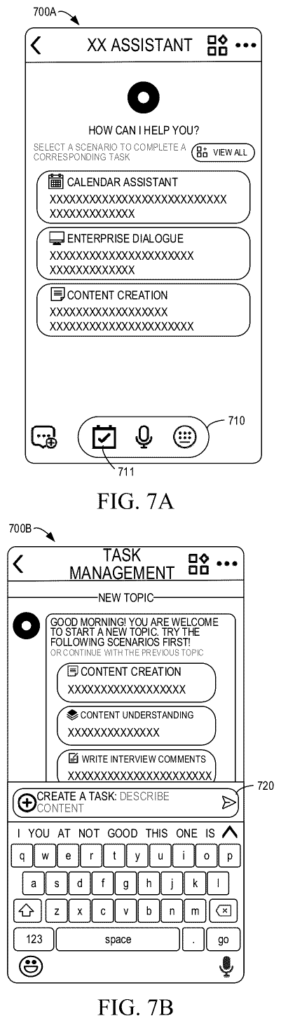

Taking the first scenario selected as a scenario “task management” as an example, the terminal device 110 may determine, based on the configuration information of the scenario “task management”, that the scenario “task management” is only associated with 1 operation control. The operation control may be, for example, a shortcut instruction control for triggering a shortcut instruction that interacts with the digital assistant in the scenario “task management”. The terminal device 110 may switch from presenting the interface 200 shown in FIG. 2 to presenting an interface 700A shown in FIG. 7A. An operation bar 710 in the interface 700A may correspond to the operation bar 210 in the interface 200. The operation bar 710 is presented with an operation control 711 corresponding to the scenario “task management” and 2 predetermined operation controls. The operation control 711 may be, for example, a shortcut instruction control for triggering a shortcut instruction that interacts with the digital assistant under the scenario “task management”. The terminal device 110 may determine, in response to receiving a trigger operation on the operation control 711, that a shortcut instruction for interacting with the digital assistant under the scenario “task management” is received.

The terminal device 110 may switch back to the session window presenting the interaction between the user and the digital assistant. For example, the terminal device 110 may present an interface 700B as shown in FIG. 7B. As shown in FIG. 7B, the terminal device 110 may present an input panel in the interface 700B. The input panel includes an input box 720. The terminal device 110 may present the received shortcut instruction (that is, an instruction “create a task”) in the input box 720. The terminal device 110 may further present, in the input box 720, prompt information related to the shortcut instruction. For example, the terminal device 110 may present the prompt information “describe content” in the input box 720. The terminal device 110 may perform a corresponding operation based on the received shortcut instruction and a text input by the user based on the prompt information.

In some embodiments, the at least one first operation control associated with the first scenario may further include a shortcut instruction list control for triggering a shortcut instruction list that interacts with the digital assistant in the first scenario. Similarly, the shortcut instruction list herein may be predetermined by the user and/or related staff or may be determined by the terminal device 110.

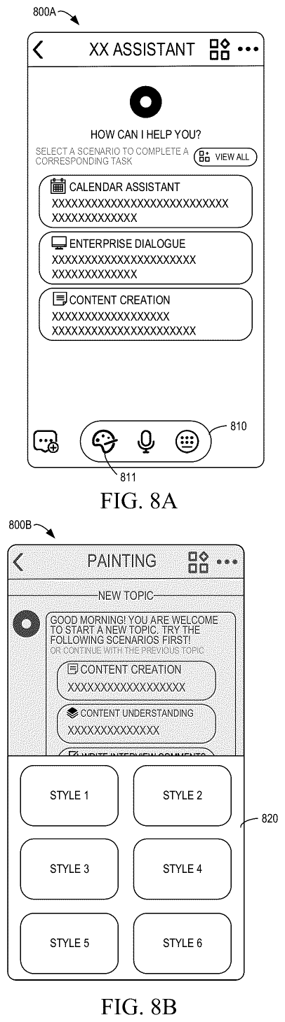

Taking the first scenario selected as a scenario “painting” as an example, the terminal device 110 may determine that the scenario “painting” is only associated with 1 operation control based on the configuration information of the scenario “painting”. The operation control may be, for example, a shortcut instruction list control for triggering a shortcut instruction list that interacts with the digital assistant in the scenario “painting”. The terminal device 110 may switch from presenting the interface 200 shown in FIG. 2 to presenting an interface 800A shown in FIG. 8A. An operation bar 810 in the interface 800A may correspond to the operation bar 210 in the interface 200. The operation bar 810 presents an operation control 811 corresponding to the scenario “painting” and 2 predetermined operation controls. The operation control 811 may be, for example, a shortcut instruction list control for triggering a shortcut instruction list that interacts with the digital assistant in the scenario “painting”. The terminal device 110 may present, in response to receiving a trigger operation on the operation control 811, a shortcut instruction list that interacts with the digital assistant under the scenario “painting”.

For example, the terminal device 110 may present an interface 800B as shown in FIG. 8B. A shortcut instruction list 820 that interacts with the digital assistant in the scenario “painting” may be presented in the interface 800B, where the shortcut instruction list 820 includes at least one shortcut instruction. The terminal device 110 may, for example, determine that the one or more shortcut instructions are received in response to detecting a selection operation on one or more shortcut instructions in the interface 800B.

The terminal device 110 may switch back to the session window presenting the interaction between the user and the digital assistant in response to receiving the one or more shortcut instructions. For example, the terminal device 110 may present an interface 800C as shown in FIG. 8C. As shown in FIG. 8C, the terminal device 110 may present an input panel in the interface 800C. The input panel includes an input box 830. The terminal device 110 may present the received shortcut instruction (for example, an instruction “style 1”) in the input box 830. The terminal device 110 may further present, in the input box 830, prompt information related to the shortcut instruction. For example, the terminal device 110 may present the prompt information “XX object” in the input box 830. The terminal device 110 may perform a corresponding operation based on the received shortcut instruction and a text input by the user based on the prompt information.

It may be understood that the at least one first operation control associated with the first scenario may include one or more of: the input control, the shortcut instruction control, and the shortcut instruction list control for the corresponding type of information input described above, and the present disclosure does not limit the at least one first operation control associated with the first scenario.

In some embodiments, in addition to providing the at least one first operation control associated with the first scenario in the interaction window (i.e., in addition to interacting in the new topic) in response to receiving the selection of the first scenario in the new topic guidance message 202 and/or in the interface 300 shown in FIG. 3, the terminal device 110 may further switch the presented at least one first operation control based on an operation of the user in the current topic.

In some embodiments, in any topic (for example, the first topic), the terminal device 110 may perform interaction with the user in the session window between the user and the digital assistant based on the currently selected scenario (for example, the first scenario) in the first topic. Specifically, the digital assistant in the terminal device 110 may analyze the session message from the user in the session window based on the configuration information of the first scenario and present a reply message for the session message from the user in the session window. The digital assistant may, for example, utilize a model to understand the user input and provide a reply to the user based on the output of the model.

In some embodiments, the terminal device 110 may further determine whether a type of a task corresponding to the current scenario matches a task indicated by the session message from the user (or may be referred to simply as determining whether the current scenario matches the session message). Taking a first session message received from the user in the first scenario as an example, for example, the terminal device 110 may determine, based on the configuration information of the first scenario, a first task type corresponding to the first scenario, and further determine whether a task indicated by the first session message matches the first task type. If the task indicated by the first session message does not match the type of the task corresponding to the first scenario (which may also be referred to simply as the first session message does not match the first scenario), the terminal device 110 may further perform intention recognition based on configuration information of another scenario and the first session message of the user, to determine an appropriate scenario (for example, a second scenario). For example, the terminal device 110 may directly switch to the second scenario after determining the second scenario matching the first session message in response to the first session message not matching the first scenario. For example, the terminal device 110 may further present scenario switching guidance information in the session window. The scenario switching guidance information is used to instruct to switch from the first scenario to the second scenario to perform the task indicated by the first session message. For example, the terminal device 110 may present a switching entry of the second scenario in the scenario switching guidance information. The terminal device 110 may switch from the first scenario to the second scenario in response to detecting a trigger operation on the switching entry.

Alternatively, or additionally, the terminal device 110 may further directly present a scenario selection control in the session window. For example, the terminal device 110 may present at least one scenario in response to detecting a trigger operation on the scenario selection control. The terminal device 110 may further switch from the first scenario to the second scenario in response to receiving a selection operation on a certain scenario (for example, the second scenario) of the at least one scenario.

In response to switching from the first scenario to the second scenario, the terminal device 110 may replace the at least one first operation control associated with the first scenario with at least one second operation control associated with the second scenario in the session window. For example, if the terminal device 110 presents 1 first operation control and 2 predetermined operation controls in the session window if the first scenario is selected. The terminal device 110 may switch from the first operation control to the second operation control in response to switching from the first scenario to the second scenario. For example, the terminal device 110 may switch to presenting 1 second operation control and 2 predetermined operation controls in the session window.

Due to the existing situation of the unequal number of the at least one first operation control and at least one second operation control, in some embodiments, if the number of the at least one first operation control is less than the number of the at least one second operation control, the terminal device 110 may replace the at least one predetermined operation control with one or more additional second operation control, so that the at least one second operation control associated with the second scenario is presented in the session window. For example, if the number of the first operation controls is 1 and the number of the second operation controls is 2, the terminal device 110 may replace the first operation control with 1 second operation control and replace one predetermined operation control with another second operation control.

In some embodiments, if the number of the at least one first operation control is greater than the number of the at least one second operation control, the terminal device 110 may replace the at least one first operation control with the at least one second operation control and replace the remaining one or more first operation controls with other at least one predetermined operation control. For example, if the number of the first operation controls is 2 and the number of the second operation controls is 1, the terminal device 110 may replace 1 first operation control with 1 second operation control and replace the other first operation control with 1 predetermined operation control of the at least one predetermined operation control previously replaced by the first operation control.

In some embodiments, if the first scenario is selected, the terminal device 110 may further detect, in the interaction between the user and the digital assistant, a first task instance initiated by the user in the first scenario and provide at least one operation control associated with the first task instance in the interaction window. The terminal device 110 may, for example, analyze a session message (for example, a first session message) from the user to determine a first task instance indicated by the first session message, and determine at least one operation control associated with the first task instance. The terminal device 110 may, for example, replace at least one first operation control associated with the first scenario with at least one operation control associated with the first task instance in the interaction window. For example, the terminal device 110 may further present at least one operation control associated with the first task instance while presenting the at least one first operation control. Similar to the scenario switching, the terminal device 110 may further replace, in response to detecting a second task instance initiated by the user in the first scenario, the previously presented at least one operation control associated with the first task instance with at least one operation control associated with the second task instance.

In summary, according to various embodiments of the present disclosure, during the interaction process between the user and the digital assistant, an operation control associated with a scenario may be presented. The digital assistant may perform an operation corresponding to the operation control in response to receiving a trigger operation on the operation control. This helps to reduce the difficulty and complexity of interaction between the user and the digital assistant and improve the interaction efficiency.

It should be understood that some embodiments of the present disclosure are described above with reference to specific examples in the accompanying drawings, but these specific examples are not intended to limit the scope of the embodiments of the present disclosure. The embodiments described may further be implemented in various other variations.

It should be understood that the interfaces shown in FIG. 2 to FIG. 8C are merely example interfaces, and various interface designs may actually exist. Individual graphical elements in the interfaces may have different arrangements and different visual representations, one or more of which may be omitted or replaced, and there may also be one or more other elements present. The embodiments of the present disclosure are not limited in this respect.

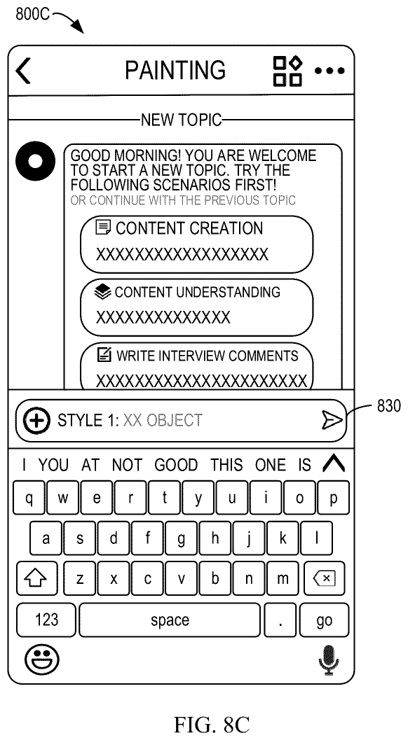

FIG. 9 illustrates a flowchart of a process 900 for information interaction according to some embodiments of the present disclosure. The process 900 may be implemented at the terminal device 110. The process 900 is described below with reference to FIG. 1.

At block 910, in an interaction window between a user and a digital assistant, in response to a first scenario of a set of scenarios being selected for an interaction between the user and the digital assistant, the terminal device 110 provides at least one first operation control associated with the first scenario in the interaction window. At least one scenario of the set of scenarios is configured to perform a task related to the corresponding scenario, and the at least one first operation control is respectively configured to trigger a corresponding operation for the interaction.

In some embodiments, the at least one scenario of the set of scenarios is configured with configuration information, and the configuration information includes at least one of: scenario setting information or plug-in information. The scenario setting information is configured to describe information related to the corresponding scenario, and the plug-in information indicates at least one plug-in for performing a task in the corresponding scenario.

In some embodiments, providing the at least one first operation control associated with the first scenario in the interaction window includes: in response to the first scenario being selected for the interaction between the user and the digital assistant, placing the at least one first operation control in front of at least one predetermined operation control in the interaction window.

In some embodiments, the interaction window includes one or more predetermined operation controls with no scenario being selected for the interaction between the user and the digital assistant, and wherein providing the at least one first operation control associated with the first scenario in the interaction window includes: in response to the first scenario being selected for the interaction between the user and the digital assistant, replacing the at least one predetermined operation control of the one or more predetermined operation controls with the at least one first operation control.

In some embodiments, the at least one first operation control associated with the first scenario includes at least one of: an input control configured to input information of a corresponding type, a shortcut instruction control configured to trigger a shortcut instruction to interact with the digital assistant in the first scenario, or a shortcut instruction list control configured to trigger a shortcut instruction list interacting with the digital assistant in the first scenario.

In some embodiments, the process 900 further includes: in response to switching from the first scenario to a second scenario, replacing the at least one first operation control associated with the first scenario with at least one second operation control associated with the second scenario in the interaction window.

In some embodiments, configuration information of the first scenario indicates the at least one first operation control associated with the first scenario.

In some embodiments, the process 900 further includes: in response to a trigger operation on a first operation control of the at least one first operation control in the interaction window, performing an operation corresponding to the first operation control.

In some embodiments, the process 900 further includes: in response to the first scenario being selected, detecting, in the interaction between the user and the digital assistant, a first task instance initiated by the user in the first scenario; and providing at least one operation control associated with the first task instance in the interaction window.

In some embodiments, the process 900 further includes: in response to receiving a scenario creation operation, providing a first page for creating a target scenario; obtaining, via the first page, target configuration information of the target scenario, the target configuration information indicating at least one operation control associated with the target scenario; and in response to receiving a creation confirmation operation, creating the target scenario based on the obtained target configuration information.

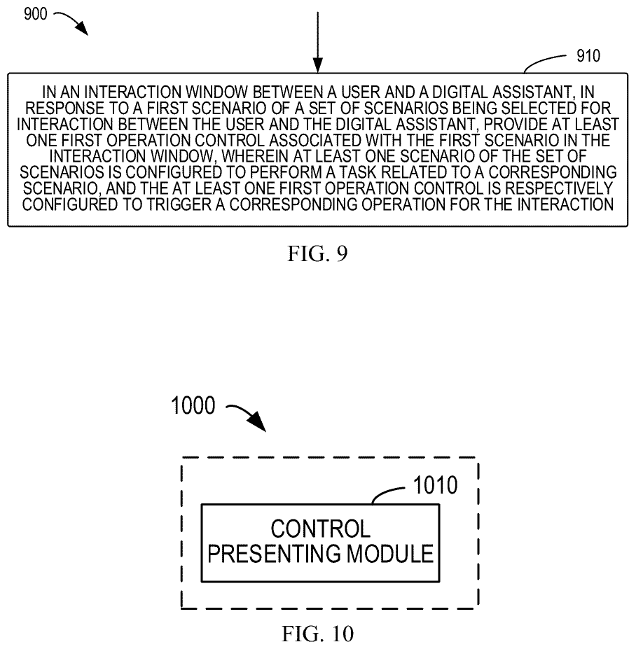

FIG. 10 illustrates a block diagram of an apparatus 1000 for information interaction according to some embodiments of the present disclosure. The apparatus 1000 may be implemented, for example, in or included in the terminal device 110. The various modules/components in the apparatus 1000 may be implemented by a hardware, software, firmware, or any combination thereof.

As shown in the figure, the apparatus 1000 includes a control presenting module 1010 configured to, in an interaction window between a user and a digital assistant, in response to a first scenario of a set of scenarios being selected for an interaction between the user and the digital assistant, providing at least one first operation control associated with the first scenario in the interaction window. At least one scenario of the set of scenarios is configured to perform a task related to the corresponding scenario, and the at least one first operation control is respectively configured to trigger a corresponding operation for the interaction.

In some embodiments, the at least one scenario of the set of scenarios is configured with configuration information, and the configuration information includes at least one of: scenario setting information or plug-in information. The scenario setting information is configured to describe information related to the corresponding scenario, and the plug-in information indicates at least one plug-in for performing a task in the corresponding scenario.

In some embodiments, the control presenting module 1010 is further configured to, in response to the first scenario being selected for the interaction between the user and the digital assistant, place the at least one first operation control in front of at least one predetermined operation control in the interaction window.

In some embodiments, the interaction window includes one or more predetermined operation controls with no scenario being selected for the interaction between the user and the digital assistant, and the control presenting module 1010 is further configured to, in response to the first scenario being selected for the interaction between the user and the digital assistant, replacing the at least one predetermined operation control of the one or more predetermined operation controls with the at least one first operation control.

In some embodiments, the at least one first operation control associated with the first scenario includes at least one of: an input control configured to input information of a corresponding type, a shortcut instruction control configured to trigger a shortcut instruction to interact with the digital assistant in the first scenario, or a shortcut instruction list control configured to trigger a shortcut instruction list interacting with the digital assistant in the first scenario.

In some embodiments, the apparatus 1000 further includes a control replacing module configured to, in response to switching from the first scenario to a second scenario, replacing the at least one first operation control associated with the first scenario with at least one second operation control associated with the second scenario in the interaction window.

In some embodiments, configuration information of the first scenario indicates the at least one first operation control associated with the first scenario.

In some embodiments, the apparatus 1000 further includes an operation execution module configured to, in response to a trigger operation on a first operation control of the at least one first operation control in the interaction window, performing an operation corresponding to the first operation control.

In some embodiments, the apparatus 1000 further includes a task detection module configured to, in response to the first scenario being selected, detecting, in the interaction between the user and the digital assistant, a first task instance initiated by the user in the first scenario; and providing at least one operation control associated with the first task instance in the interaction window.

In some embodiments, the apparatus 1000 further includes a page providing module configured to, in response to receiving a scenario creation operation, providing a first page for creating a target scenario; obtaining, via the first page, target configuration information of the target scenario, the target configuration information indicating at least one operation control associated with the target scenario; and in response to receiving a creation confirmation operation, creating the target scenario based on the obtained target configuration information.

It should be understood that one or more steps of the above methods may be performed by an appropriate electronic device or a combination of electronic devices. Such electronic devices or a combination of electronic devices may include, for example, the server 130, the terminal device 110, and/or a combination of the server 130 and the terminal device 110 in FIG. 1.

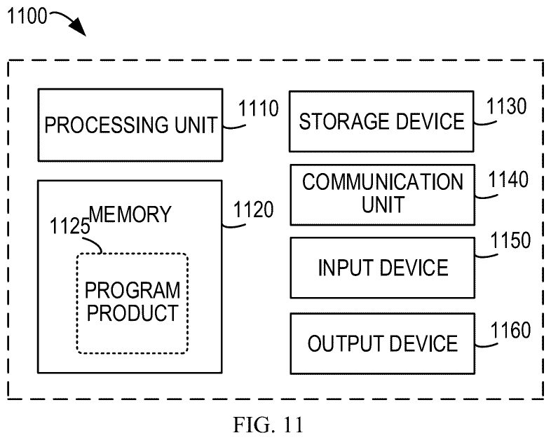

FIG. 11 illustrates a block diagram of an electronic device 1100 in which one or more embodiments of the disclosure may be implemented. It should be understood that the electronic device 1100 shown in FIG. 11 is merely an example and should not constitute any limitation on the function and scope of the embodiments described herein. The electronic device 1100 shown in FIG. 11 may be configured to implement the terminal device 110 and/or the server 120 in FIG. 1, or the apparatus in FIG. 14.

As shown in FIG. 11, the electronic device 1100 is in the form of a general-purpose electronic device. Components of the electronic device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In multiprocessor systems, multiple processing units execute computer-executable instructions in parallel to improve parallel processing capabilities of electronic device 1100.

The electronic device 1100 typically includes a plurality of computer storage media. Such media may be any available media accessible by the electronic device 1100, including, but not limited to, volatile and non-volatile media, removable and non-removable media. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data and may be accessed within electronic device 1100.

The electronic device 1100 may further include additional removable/non-removable, volatile/non-volatile storage media. Although not shown in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1120 may include a computer program product 1125 having one or more program modules configured to perform various methods or actions of various embodiments of the disclosure.

The communications unit 1140 implements communications with other electronic devices over a communications medium. Additionally, the functionality of components of the electronic device 1100 may be implemented in a single computing cluster or multiple computing machines capable of communicating over a communication connection. Thus, the electronic device 1100 may operate in a networked environment using logical connections with one or more other servers, network personal computers (PCs), or another network node.

The input device 1150 may be one or more input devices, such as a mouse, a keyboard, a trackball, or the like. The output device 1160 may be one or more output devices, such as a display, a speaker, a printer, or the like. The electronic device 1100 may further communicate with one or more external devices (not shown) through the communication unit 1140 as needed, external devices such as storage devices, display devices, etc., communicate with one or more devices that enable a user to interact with the electronic device 1100, or communicate with any device (e.g., a network card, a modem, etc.) that enables the electronic device 1100 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may further be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operation steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may further occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

I/we claim:

1. A method for information interaction, comprising:
in an interaction window between a user and a digital assistant, in response to a first scenario of a set of scenarios being selected for an interaction between the user and the digital assistant, providing at least one first operation control associated with the first scenario in the interaction window,
wherein at least one scenario of the set of scenarios is configured to perform a task related to the corresponding scenario, and the at least one first operation control is respectively configured to trigger a corresponding operation for the interaction.

2. The method of claim 1, wherein the at least one scenario of the set of scenarios is configured with configuration information, and the configuration information comprises at least one of: scenario setting information or plug-in information,
wherein the scenario setting information is configured to describe information related to the corresponding scenario, and the plug-in information indicates at least one plug-in for performing a task in the corresponding scenario.

3. The method of claim 1, wherein providing the at least one first operation control associated with the first scenario in the interaction window comprises:
in response to the first scenario being selected for the interaction between the user and the digital assistant, placing the at least one first operation control in front of at least one predetermined operation control in the interaction window.

4. The method of claim 1, wherein the interaction window comprises one or more predetermined operation controls with no scenario being selected for the interaction between the user and the digital assistant, and wherein providing the at least one first operation control associated with the first scenario in the interaction window comprises:
in response to the first scenario being selected for the interaction between the user and the digital assistant, replacing the at least one predetermined operation control of the one or more predetermined operation controls with the at least one first operation control.

5. The method of claim 1, wherein the at least one first operation control associated with the first scenario comprises at least one of:
an input control configured to input information of a corresponding type,
a shortcut instruction control configured to trigger a shortcut instruction to interact with the digital assistant in the first scenario, or
a shortcut instruction list control configured to trigger a shortcut instruction list interacting with the digital assistant in the first scenario.

6. The method of claim 1, further comprising:
in response to switching from the first scenario to a second scenario, replacing the at least one first operation control associated with the first scenario with at least one second operation control associated with the second scenario in the interaction window.

7. The method of claim 1, wherein configuration information of the first scenario indicates the at least one first operation control associated with the first scenario.

8. The method of claim 1, further comprising:
in response to a trigger operation on a first operation control of the at least one first operation control in the interaction window, performing an operation corresponding to the first operation control.

9. The method of claim 1, further comprising:
in response to the first scenario being selected, detecting, in the interaction between the user and the digital assistant, a first task instance initiated by the user in the first scenario; and
providing at least one operation control associated with the first task instance in the interaction window.

10. The method of claim 1, further comprising:
in response to receiving a scenario creation operation, providing a first page for creating a target scenario;
obtaining, via the first page, target configuration information of the target scenario, the target configuration information indicating at least one operation control associated with the target scenario; and
in response to receiving a creation confirmation operation, creating the target scenario based on the obtained target configuration information.

11. An electronic device comprising:
at least one processing unit; and
at least one memory coupled to the at least one processing unit and storing instructions for execution by the at least one processing unit, the instructions, when executed by the at least one processing unit, causing the electronic device to perform acts of information interaction, the acts comprising:
in an interaction window between a user and a digital assistant, in response to a first scenario of a set of scenarios being selected for an interaction between the user and the digital assistant, providing at least one first operation control associated with the first scenario in the interaction window,
wherein at least one scenario of the set of scenarios is configured to perform a task related to the corresponding scenario, and the at least one first operation control is respectively configured to trigger a corresponding operation for the interaction.

12. The device of claim 11, wherein the at least one scenario of the set of scenarios is configured with configuration information, and the configuration information comprises at least one of: scenario setting information or plug-in information,
wherein the scenario setting information is configured to describe information related to the corresponding scenario, and the plug-in information indicates at least one plug-in for performing a task in the corresponding scenario.

13. The device of claim 11, wherein providing the at least one first operation control associated with the first scenario in the interaction window comprises:
in response to the first scenario being selected for the interaction between the user and the digital assistant, placing the at least one first operation control in front of at least one predetermined operation control in the interaction window.

14. The device of claim 11, wherein the interaction window comprises one or more predetermined operation controls with no scenario being selected for the interaction between the user and the digital assistant, and wherein providing the at least one first operation control associated with the first scenario in the interaction window comprises:
in response to the first scenario being selected for the interaction between the user and the digital assistant, replacing the at least one predetermined operation control of the one or more predetermined operation controls with the at least one first operation control.

15. The device of claim 11, wherein the at least one first operation control associated with the first scenario comprises at least one of:
an input control configured to input information of a corresponding type,
a shortcut instruction control configured to trigger a shortcut instruction to interact with the digital assistant in the first scenario, or
a shortcut instruction list control configured to trigger a shortcut instruction list interacting with the digital assistant in the first scenario.

16. The device of claim 11, wherein the acts further comprise:
in response to switching from the first scenario to a second scenario, replacing the at least one first operation control associated with the first scenario with at least one second operation control associated with the second scenario in the interaction window.

17. The device of claim 11, wherein configuration information of the first scenario indicates the at least one first operation control associated with the first scenario.

18. The device of claim 11, wherein the acts further comprise:
in response to a trigger operation on a first operation control of the at least one first operation control in the interaction window, performing an operation corresponding to the first operation control.

19. The device of claim 11, wherein the acts further comprise:
in response to the first scenario being selected, detecting, in the interaction between the user and the digital assistant, a first task instance initiated by the user in the first scenario; and
providing at least one operation control associated with the first task instance in the interaction window.

20. A non-transitory computer readable storage medium having stored thereon a computer program executable by a processor to implement acts of information interaction, the acts comprising:
in an interaction window between a user and a digital assistant, in response to a first scenario of a set of scenarios being selected for an interaction between the user and the digital assistant, providing at least one first operation control associated with the first scenario in the interaction window,
wherein at least one scenario of the set of scenarios is configured to perform a task related to the corresponding scenario, and the at least one first operation control is respectively configured to trigger a corresponding operation for the interaction.
